(19) United States
(12) Patent Application Publication
(10) Pub. No.: US 2026/0367612 A1
(43) Pub. Date: Nov. 19, 2026

(54) SYSTEMS AND METHODS FOR PROVIDING REPORT RECOMMENDATIONS IN A FACILITY

(71) Applicant: Honeywell International Inc., Charlotte, NC (US)

(72) Inventors: Kartikeyan Bollapalli, Bangalore (IN); Ankit Singh, Apex, NC (US); Waad Subber, Schenectady, NY (US)

(21) Appl. No.: 19/209,836

(22) Filed: May 16, 2025

(51) Int. Cl. G05B 19/418; G06F 16/334

(52) U.S. Cl. CPC G05B 19/41865; G06F 16/3347

(57) ABSTRACT

Various embodiments described herein relate to systems and methods for providing report recommendations in a facility. In this regard, one or more details of a product is received from a user associated with the facility via a user interface. Then, information related to the product is fetched from one or more databases associated with the facility. Based on the one or more details and the information related to the product, one or more prompts are generated. Using the one or more prompts, one or more report configurations are then retrieved. Considering at least the one or more report configurations, a report configuration list is further generated. Also, the report configuration list is rendered to the user via the user interface such that the report configuration list comprises one or more report recommendations for the product in consideration.

### TECHNICAL FIELD

The present disclosure relates generally to management of data in a facility. More particularly, the present disclosure relates to providing one or more report recommendations in the facility.

### BACKGROUND

Generally, a facility under life sciences sector often undertakes diverse processes to manufacture several life sciences products such as drug products, medical equipment, chemicals, and/or the like. Such products from the facility are often expected to be of the utmost quality as they play a crucial role in human life. In this regard, various aspects relating to such products are expected to meet certain requirements set forth by compliance authorities. Such compliance ensures that different products meet the desired quality. For compliance verification, the compliance authorities expect the facility to report data associated with products and processes at regular intervals. For this, typically the facility relies on subject matter experts or domain experts to manually create one or more reports using the data associated with products and processes in the facility. However, this has associated challenges. Given that the facility includes different domains and diverse processes along with numerous product lines, the data associated with products and processes in the facility becomes humongous. Manually handling such a large quantity of data becomes a complicated task say, while creating a report for a specific product that might only require a relevant portion from vast pool of the data. Further, such manual work is often error prone as the experts may fail to accurately scale up to said huge volume of data. Due to such errors, handling of the data to create relevant report(s) in the facility becomes a challenging task.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary report recommendation system, in accordance with one or more example embodiments described herein.

FIG. 4 illustrates a schematic diagram showing an exemplary block diagram associated with one or more operations of exemplary report recommendation system, in accordance with one or more example embodiments described herein.

FIG. 5 illustrates a flowchart showing a method described in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for providing one or more report recommendations in a facility is described herein. In this regard, the method comprises receiving one or more details of a product from a user associated with the facility. In this regard, the one or more details may be received via a user interface. Then, the method comprises fetching information related to the product from one or more databases associated with the facility. Further, the method comprises generating one or more prompts based on the one or more details and the information related to the product. Furthermore, the method comprises retrieving one or more report configurations based on the one or more prompts. The method then comprises generating a report configuration list based at least on the one or more report configurations. Also, the method comprises rendering the report configuration list to the user via the user interface such that the report configuration list comprises the one or more report recommendations.

In accordance with another embodiment of the current disclosure, a system for providing one or more report recommendations in a facility is described herein. The system comprises a processor and a memory communicatively coupled to the processor, wherein the memory comprises one or more instructions which when executed by the processor, cause the processor to receive one or more details of a product from a user associated with the facility via a user interface. The processor is also configured to fetch information related to the product from one or more databases associated with the facility. Further, the processor is configured to generate one or more prompts based on the one or more details and the information related to the product. Furthermore, the processor is configured to retrieve one or more report configurations based on the one or more prompts. Also, the processor is configured to generate a report configuration list based at least on the one or more report configurations. Additionally, the processor is also configured to render the report configuration list to the user via the user interface such that the report configuration list comprises the one or more report recommendations.

In accordance with yet another embodiment of the current disclosure, a non-transitory, computer-readable storage medium having instructions stored thereon and executable by one or more processors is described herein. In this regard, the instructions when executed by one or more processors cause the one or more processors to receive one or more details of a product from a user associated with the facility via a user interface. The one or more processors are also configured to fetch information related to the product from one or more databases associated with the facility. Further, the one or more processors are configured to generate one or more prompts based on the one or more details and the information related to the product. Furthermore, the one or more processors are configured to retrieve one or more report configurations based on the one or more prompts. Also, the one or more processors are configured to generate a report configuration list based at least on the one or more report configurations. Additionally, the one or more processors are also configured to render the report configuration list to the user via the user interface such that the report configuration list comprises the one or more report recommendations.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases "in an embodiment," "in one embodiment," "according to one embodiment," and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word "exemplary" is used herein to mean "serving as an example, instance, or illustration." Any implementation described herein as "exemplary" is not necessarily to be construed as preferred or advantageous over other implementations. If the specification states a component or feature "can," "may," "could," "should," "would," "preferably," "possibly," "typically," "optionally," "for example," "often," or "might" (or other such language) be included or have a characteristic, that particular component or feature is not required to be included or to have the characteristic. Such component or feature can be optionally included in some example embodiments, or it can be excluded.

More specifically, products and processes associated with a facility related to life sciences are governed by different regulations set forth by compliance authorities across various geographical locations. For example, a drug product from a facility such as a pharmaceutical industry may be expected to meet defined requirements such as, but not limited to Good Manufacturing Practice (GMP) regulations set forth by appropriate compliance authorities. To ensure such compliance, the facility provides appropriate data as report(s) associated with relevant products and/or processes in a timely manner to suitable compliance authorities. For example, a drug company may be required to perform annual product quality review (APQR) for drug product(s) it manufactures and provide an APQR report to appropriate regulatory for compliance verification. Traditionally, the facility relies on expertise of technical or subject matter experts to come up with such report(s). For example, while creating a report for a specific product, a subject matter expert may be required to manually onboard that product initially. Then, the subject matter expert may be required to manually configure various data sources and parameters from those data sources which would be used in reporting chapters of the report. Further, the subject matter expert may create the report by manually adding required chapters depending on a type of the product that was onboarded. Each chapter may have several plots/charts based on the parameters from the earlier configured data sources. It is to be noted that such manual work is associated with several challenges. As it may be understood, the data associated with products and processes in the facility is usually of huge volume as it is generated from diverse processes and numerous product lines. Additionally, the data associated with various aspects of products and processes may be stored in different databases. Manually processing such huge volume of data from different databases may be subjected to errors as the experts may fail to accurately scale up to such huge volume of data. Also, the experts may fail to appropriately segregate the data from various databases and consider all relevant data related to a particular product and/or a particular process from such huge volume of data. Such manual work is a cumbersome task as well. In view of such shortcomings, preparation of appropriate report(s) becomes a difficult task for the facility.

Thus, to address the above challenges, various example embodiments described herein develop systems and methods for providing one or more report recommendations in a facility. In this regard, for instance, the system described herein is configured to leverage prompt engineering techniques to provide appropriate report recommendation(s) to users associated with the facility. Initially, the system described herein receives one or more details of a product via a user interface from a user associated with the facility. The product may correspond to that product of interest for which a report is to be created. The one or more details provided by the user may be, but not limited to raw material ingredients associated with the product, manufacturing data related to the product, and/or the like. The user provides such details to the system so as to onboard that product for which a report is to be created. Upon receiving the one or more details, the system described herein fetches information related to the product from one or more databases associated with the facility. The one or more databases may be configured to store various aspects relevant to products and/or processes associated with the facility. In this regard, the one or more databases may store data such as raw material information, manufacturing conditions, storing conditions, product genealogy, and/or the like related to various products and/or various processes. It is also to be noted that the data may be stored in the one or more databases in a distributed manner. From such a pool of data in the one or more databases, the system fetches the information related to the product considering the one or more details into account. In this regard, the information may comprise raw material information, manufacturing conditions, storing conditions, product genealogy, and/or the like associated with the product.

Also, the system described herein generates one or more prompts based on the one or more details and the information related to the product. The one or more prompts are framed by the system considering the information fetched from the one or more databases along with the one or more details. That is, the system initially derives the context from the one or more details. Based on the context, the system frames the one or more prompts considering the fetched information such as raw material information, manufacturing conditions, storing conditions, product genealogy, and/or the like associated with the product. In this regard, the system may selectively choose one or more attributes from the fetched information to frame the one or more prompts. Also, it is to be appreciated that the system considers inter-relationship between different attributes in the information in view of generating the one or more prompts. The system then utilizes the one or more prompts to retrieve one or more report configurations. In this regard, the system provides the one or more prompts to large language model(s) (LLM) in order to retrieve the one or more report configurations. The one or more report configurations often correspond to common report configurations provided by the system for those products whose context and/or attributes is similar to the product for which the report is to be generated. The one or more report configurations may be stored in the one or more databases. Additionally, it is to be appreciated that the system also retrieves one or more historical report configurations while providing the one or more report recommendations. The one or more historical report configurations often correspond to those report configurations provided by the system for those products similar to the product for which the report is to be generated. The one or more historical report configurations may be stored in the one or more databases.

Based on the one or more report configurations and the one or more historical report configurations, the system described herein generates a report configuration list. The report configuration list comprises the one or more report recommendations for the product in consideration. Additionally, the one or more report recommendations in the report configuration list are ranked as well. The system generally ranks the one or more report recommendations based at least on the relevance of each of the one or more report recommendations to the product for which the report is to be created. In view of generating the report configuration list, the system compares the one or more report configurations with the one or more historical report configurations. In this regard, the system initially generates corresponding vectorial representations for each of the one or more report configurations and each of the one or more historical report configurations. Then, the system compares a vectorial representation of a report configuration with another vectorial representation of a historical report configuration. Based on this, the system determines a similarity score of one or more similarity scores for each of such comparison to generate the report configuration list. Also, it is to be noted that the one or more report recommendations are ranked considering the one or more similarity scores as well. Upon generating the report configuration list, the system also makes sure to render the report configuration list to the user via the user interface.

Upon rendering, the user may also provide an input corresponding to a selection of a report recommendation from amongst the one or more report recommendations. Also, at times, the input provided by the user may correspond to a recommendation to merge few report recommendations from amongst the one or more report recommendations. It is to be noted that the user may provide the input via the user interface. In view of such input, the system may create the report for the product in consideration based on the context, relevant attributes and report configuration(s), and/or appropriate historical report configuration(s). Such report may also be rendered by the system via the user interface as well. Additionally, the user may also provide feedback on the report configuration list and/or the report rendered. It is to be appreciated that the system learns from such feedback over the time to improvise its report recommendation(s) and report generation capabilities. Accordingly, the proposed system automates generation of report(s) for appropriate product(s) thereby reducing manual effort and increasing efficiency. The system also ensures standardization and consistency across reports, minimizing variability and adhering to industry standards. By leveraging historical data and large language model(s) (LLM), the system generates accurate and relevant report configurations. Additionally, the system allows users to customize reports based on specific needs at times, enhancing flexibility. The system connects to various databases, ensuring comprehensive data utilization and thorough reports. The system proposed herein is scalable, suitable for different products and industries, and supports improved decision-making by providing ranked report configurations. Overall, the system saves time and enhances productivity by streamlining report generation in the facility.

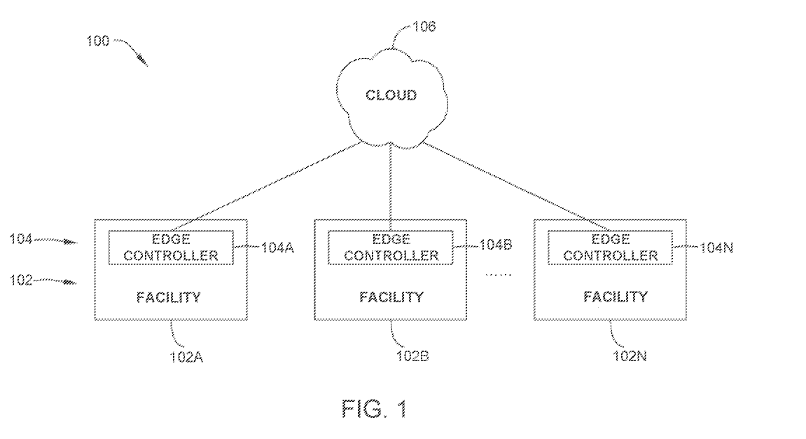

FIG. 1 illustrates a schematic diagram showing an exemplary environment comprising multiple facilities. According to various example embodiments described herein, an exemplary environment 100 comprises one or more facilities 102a, 102b,....102n (collectively “facilities 102”). In some example embodiments, a facility of the one or more facilities 102a, 102b,....102n may correspond to, for example, a building, a factory, a pharmaceutical industry, an industrial plant, and/or the like related to life sciences sector. In some example embodiments, the one or more facilities 102a, 102b,....102n in the illustrative environment 100 may be of same type. In some example embodiments, the one or more facilities 102a, 102b,....102n in the illustrative environment 100 may be of different type. As it may be understood, in some example embodiments described herein, a facility of the one or more facilities 102a, 102b,....102n often manufactures several life sciences products such as drug products, medical equipment, chemicals, and/or the like. In this regard, the facility often incorporates several diverse processes to manufacture such life sciences products. Such products manufactured at the facility along with the associated processes are expected to meet standards as set forth by one or more compliance authorities. Per this aspect, the facility is required to report data associated with the products along with the processes to appropriate compliance authorities in a timely manner. For example, a pharmaceutical industry may be required to perform annual product quality review (APQR) for a drug product it manufactures and provide an APQR report to appropriate compliance authority annually. In view of reporting the data to authorities, the facility often maintains storage say, database(s) in order to store the data associated with the products along with the processes. It is to be noted that the facility is required to selectively report some portions of the data to appropriate compliance authority as a part of reporting the data for a specific product and/or a particular process. Said alternatively, the facility need not report all of the data to appropriate compliance authority but only report those portions of the data based on requirement(s) for corresponding product and/or associated process. Per this aspect, it also becomes essential to opt for proper report configuration(s) in the course of preparing APQR report(s). Provided that the data associated with the products and the processes is of substantial volume, it becomes essential to accurately select relevant portions of the data and report it to appropriate compliance authority in suitable report configurations to avoid non-compliance issues.

In some example embodiments, a cloud 106 is operably coupled with one or more facilities 102a, 102b,....102n, meaning that communication between the cloud 106 and one or more facilities 102a, 102b,....102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services to provide suitable report recommendations for user(s) in the facility. Per this aspect, the one or more services of the cloud 106 appropriately handle, process, and/or manage the data at the cloud 106 to derive report recommendations by leveraging prompt engineering techniques. In this regard, the data at the cloud 106 comprises one or more data records which comprise information related to product(s) and/or process(es) of the facility. For example, some data records may comprise quality parameters associated with certain products while some other data records may comprise process parameters associated with certain processes. Additionally, the data at the cloud 106 comprises one or more swagger files which include relevant metadata of the one or more data records along with a schema of the one or more data records and a schema of the database. Also, the cloud 106 may include or generate models required to handle, process, and/or manage the data in order to provide suitable report recommendations for user(s) in the facility. In some example embodiments, the cloud 106 includes one or more servers that may be programmed to communicate with the one or more facilities 102a, 102b,....102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of different processes with regards to manufacturing life sciences products. For example, in a facility such as a pharmaceutical industry, there may be several processes related to research and development, material handling, shipping, quality assurance, law/legal, and/or the like associated with manufacturing of a drug product. In view of such diversity, the data related to product(s) and/or process(es) also becomes diverse. Accordingly, volume of the data associated with the products along with the processes becomes relatively substantial and complex in nature. For example, a data record may comprise batch number of a drug product while another related data record may comprise recall history of related drug products. In another example, a data record may comprise a geographical region where a drug product is manufactured while another related data record may comprise process parameters associated with manufacturing of the drug product. In the example shown in FIG. 1, each of the one or more facilities 102a, 102b,....102n includes a respective edge controller (alternatively, edge gateway) 104a, 104b,....104n (collectively “edge controllers 104” or “edge gateways 104”). In some example embodiments, each of one or more edge controllers 104a, 104b,.... 104n is configured to receive the data from the respective facilities 102. In some examples, the one or more edge controllers 104a, 104b,.... 104n may operate as intermediary node to transact the data between the facilities 102 and/or the cloud 106. In this regard, the data transacted comprises the one or more data records having all relevant information associated with product(s) and/or process(es) in the facility along with appropriate swagger files and related schemas. In some examples, each of the one or more edge controllers 104a, 104b,.... 104n is capable of receiving the data from disparate data sources e.g., but not limited to, in different data formats and/or using various data communication protocols, from the facilities 102. In this regard, each of the one or more edge controllers 104a, 104b,.... 104n can receive & filter the data and translate the data into a common language and/or format (e.g. normalized data) for subsequent communication to the cloud 106. The common language and/or format may be compatible with and expected by the cloud 106.

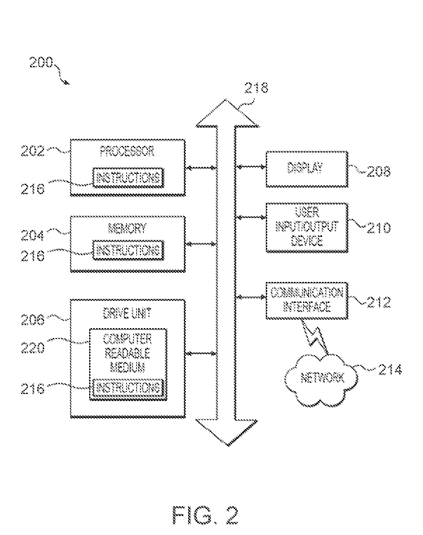

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

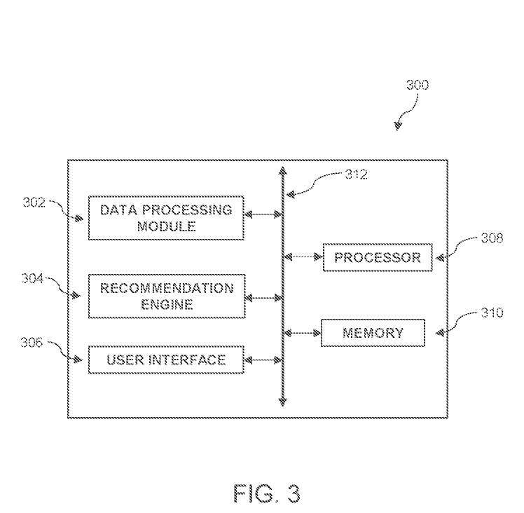

FIG. 3 illustrates a schematic diagram showing an implementation of an exemplary report recommendation system, in accordance with one or more example embodiments described herein. In one or more example embodiments, the report recommendation system 300 described herein leverages prompt engineering techniques to provide appropriate report recommendation(s) to user(s) associated with the facility (for instance, one or more facilities 102a, 102b,....102n as described in FIG. 1 of the current disclosure). In this regard, the report recommendation system 300 initially receives detail(s) of a product via a user interface from a user associated with the facility. The product may correspond to that product of interest for which a report is to be created. Per this aspect, in some examples, the report may correspond to an APQR report that is to be created for the product for which the detail(s) are received from the user. Then, the report recommendation system 300 fetches information related to the product from database(s) associated with the facility. The database(s) may be configured to store various aspects relevant to products and/or processes associated with the facility. Further, the report recommendation system 300 generates prompt(s) based on the detail(s) and the information related to the product. Using such prompts, the report recommendation system 300 retrieves one or more report configurations. In this regard, the report recommendation system 300 utilizes one or more trained large language models to retrieve the one or more report configurations. Additionally, the report recommendation system 300 also retrieves one or more historical report configurations at this point as well. Upon retrieval of appropriate report configurations, the report recommendation system 300 generates a report configuration list which comprises the one or more report recommendations for the product in consideration. Then, the report recommendation system 300 also makes sure to render the report configuration list to the user via the user interface. Upon rendering, the user may also provide relevant input(s) and/or appropriate feedback to the report recommendation system 300 via the user interface. With this, the report recommendation system 300 automates generation of report(s) for appropriate product(s) and/or process(es) thereby reducing manual effort and increasing efficiency. The report recommendation system 300 also ensures standardization and consistency across reports, minimizing variability and adhering to industry standards. By leveraging historical data and large language model(s) (LLM), the report recommendation system 300 generates accurate and relevant report configurations.

In some example embodiments, the report recommendation system 300 is a server system (e.g., a server device) that facilitates a data analytics platform between one or more computing devices, one or more data sources, and/or one or more facilities. In some example embodiments, the report recommendation system 300 is a device with one or more processors and a memory. Also, in some example embodiments, the report recommendation system 300 is implementable via the cloud 106. The report recommendation system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the report recommendation system 300 comprises one or more components such as, a data processing module 302, a recommendation engine 304, and/or a user interface 306. Additionally, in one or more example embodiments, the report recommendation system 300 comprises a processor 308 and/or a memory 310. In one or more example embodiments, one or more components of the report recommendation system 300 may be communicatively coupled to the processor 308 and/or the memory 310 via a bus 312. In certain example embodiments, one or more aspects of the report recommendation system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the report recommendation system 300, a remote processor (e.g., a processor implemented on a server), and/or a virtual machine. In certain example embodiments, the processor 308 is in communication with the memory 310, the data processing module 302, the recommendation engine 304, and/or the user interface 306 via the bus 312 to, for example, facilitate transmission of data between the processor 308, the memory 310, the data processing module 302, the recommendation engine 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the report recommendation system 300 to carry out various functions in accordance with one or more embodiments disclosed herein. In accordance with some example embodiments described herein, the memory 310 may correspond to an internal or external memory of the report recommendation system 300. In some examples, the memory 310 may correspond to a database communicatively coupled to the report recommendation system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the data processing module 302 initially receives one or more details of the product. These details are often received from the user associated with the facility. In this regard, the user provides the one or more details to the report recommendation system 300 thereby to the data processing module 302 via the user interface 306 and/or a computing device (not shown) associated with the user. The user may correspond to personnel of the facility and/or an employee of an organization different from the facility (for example, a third-party service provider hired by the facility). While the said product may correspond to that product of interest for which the report is to be created. For example, the report may correspond to an APQR report that is to be created for the product so as to ensure that appropriate compliance requirements are met. Also, the product may be one of one or more products associated with the facility. That is, for instance, the facility may be directly or indirectly involved in manufacturing of the said product. Further, the one or more details provided by the user may be, but not limited to raw material ingredients associated with the product, manufacturing data related to the product, and/or the like. Per this aspect, the one or more details may be received in the form of text and/or audio via the user interface 306 and/or the computing device. For example, a user such as an operator in the facility may provide key ingredients such as potassium, magnesium, and/or the like of a pharma product as detail(s). In another example, another user such as a manager associated with the facility may provide quality parameters related to a drug product as detail(s). The user provides such details to the report recommendation system 300 so as to onboard that product for which the report is to be created. That is, the report recommendation system 300 identifies appropriate database(s) which include relevant information related to the product in view of onboarding that product. In this regard, the data processing module 302 identifies appropriate database(s) considering detail(s) provided by the user.

Further, in one or more example embodiments, the data processing module 302 of the report recommendation system 300 fetches the information related to the product from one or more databases associated with the facility. The data processing module 302 may utilize the fetched information to determine one or more quality parameters associated with the product as well. In this regard, the information may comprise raw material information, manufacturing conditions, storing conditions, product genealogy, and/or the like associated with the product. The one or more databases are mostly identified by the data processing module 302 based on the one or more details provided by the user. Also, the one or more databases may be configured to store various aspects relevant to products and/or processes associated with the facility. In this regard, the one or more databases may store data such as raw material information, manufacturing conditions, storing conditions, product genealogy, and/or the like related to various products and/or various processes. It is also to be noted that the data may be stored in the one or more databases in a distributed manner as well. From such a pool of data in the one or more databases, the data processing module 302 fetches the information related to the product considering the one or more details into account. It is to be noted that to fetch such relevant information, the data processing module 302 queries the one or more databases considering the one or more details received for the product. For example, a user may provide key ingredients such as potassium, magnesium, and/or the like of a pharma product as detail(s). Considering potassium, magnesium, and/or the like, the data processing module 302 may identify those database(s) which include relevant data associated with those product(s) whose key ingredients constitute potassium, magnesium, and/or the like. Upon identification of such database(s), the data processing module 302 may fetch appropriate information related to the pharma product from such database(s).

Then, in one or more example embodiments described herein, the data processing module 302 generates one or more prompts based on the one or more details and the information related to the product. In this regard, the data processing module 302 initially derives the context from the one or more details. Based on the context, the data processing module 302 frames the one or more prompts considering the information fetched from the one or more databases. That is, the data processing module 302 frames the one or more prompts considering at least the fetched information such as raw material information, manufacturing conditions, storing conditions, product genealogy, and/or the like associated with the product. For example, the data processing module 302 may fetch relevant information from database(s) which include relevant data associated with those product(s) whose key ingredients constitute potassium, magnesium, and/or the like as per detail(s) provided by a user. In this regard, the fetched information may comprise raw material information with potassium and magnesium as key ingredients along with other constituents, manufacturing conditions based on quality parameter(s), storing conditions indicating various storage requirements (expected and/or undertaken) for those product(s), product genealogy indicating history of product(s) and/or lineage of product(s) throughout their lifecycle (say, from raw materials to finished form and further), and/or the like. Then, the data processing module 302 considering the fetched information and/or the key ingredients may frame a prompt which may correspond to “Give me top quality management system reports for a pharma product which has potassium and magnesium as key ingredients”.

Also, it is to be appreciated that while framing the one or more prompts, the data processing module 302 may selectively choose one or more attributes from the fetched information. In this regard, the data processing module 302 may also consider inter-relationship between different attributes in the information in view of generating the one or more prompts. For instance, the data processing module 302 may selectively choose amongst attribute(s) such as, but not limited to raw material information, manufacturing conditions, storing conditions, product genealogy, and/or the like associated with the product. Additionally, the data processing module 302 may consider inter-relationship between attribute(s) such as, but not limited to raw material information, manufacturing conditions, storing conditions, product genealogy, and/or the like associated with the product while generating the one or more prompts.

Further, in one or more example embodiments described herein, the data processing module 302 retrieves the one or more report configurations using the one or more prompts. In this regard, the data processing module 302 provides the one or more prompts to one or more large language models (LLMs) as appropriate in order to retrieve the one or more report configurations. It is to be appreciated that the one or more LLMs are well trained using relevant datasets in view of retrieving relevant report configuration(s). The one or more report configurations often correspond to common report configurations provided by the data processing module 302 for those product(s) whose context and/or attributes is similar to the product for which the report is to be generated. For instance, the common report configurations may correspond to those report configurations which serve as template report configurations formed based at least on commonality/similarity with respect to context and/or attributes of product(s). It is to be noted that the one or more report configurations may be stored in the one or more databases. Additionally, it is to be appreciated that, in one or more example embodiments, the data processing module 302 also retrieves the one or more historical report configurations while providing the one or more report recommendations. The one or more historical report configurations often correspond to those report configurations provided by the data processing module 302 for those product(s) similar to the product for which the report is to be generated. That is, the one or more historical report configurations comprise at least one report configuration associated with at least one product similar to the product for which the one or more details are received. The one or more historical report configurations may also be stored in the one or more databases as well.

Then, in one or more example embodiments, the recommendation engine 304 generates the report configuration list. In this regard, the report configuration list is generated by the recommendation engine 304 based on the one or more report configurations and/or the one or more historical report configurations. It is to be noted that the report configuration list comprises the one or more report recommendations for the product in consideration. In view of generating the report configuration list, the recommendation engine 304 compares the one or more report configurations with the one or more historical report configurations. In this regard, the recommendation engine 304 initially generates corresponding vectorial representations for each of the one or more report configurations along with each of the one or more historical report configurations. For instance, one or more first vectorial representations may be generated for the one or more report configurations while one or more second vectorial representations may be generated for the one or more historical report configurations. Then, the recommendation engine 304 compares a first vectorial representation of a report configuration with related second vectorial representation(s) of historical report configuration(s). Based on this, the recommendation engine 304 determines a similarity score for each of such comparisons. The recommendation engine 304 determines the similarity score based on a degree of similarity (alternatively, a degree of dissimilarity) between vectorial representations that are compared. Per this aspect, the recommendation engine 304 determines one or more similarity scores based on such comparisons. Also, the recommendation engine 304 ranks the one or more report recommendations in the report configuration list. In this regard, the recommendation engine 304 ranks the one or more report recommendations considering the one or more similarity scores. That is, the recommendation engine 304 ranks the one or more report recommendations based at least on the relevance of each of the one or more report recommendations to the product for which the report is to be created based on the one or more similarity scores. It is to be noted that a report recommendation of the one or more report recommendations comprises a suggested report configuration with one or more chapters, one or more parameters (such as, but not limited to quality parameters, process parameters, and/or the like) related to product in consideration, one or more types of graphical representation (such as, but not limited to pie, bar, and/or the like as plots/charts) to represent the one or more parameters, one or more formatting suggestions, and/or the like.

Additionally, in one or more example embodiments, the recommendation engine 304 makes sure to render the report configuration list to the user via at least the user interface 306. Also, in some embodiments, the recommendation engine 304 may render the report configuration list to the user via a computing device (not shown) associated with the user as well. Upon rendering, the user may provide relevant input(s) to the report recommendation system 300 thereby to the recommendation engine 304 say, via the user interface 306. For instance, the user may provide an input corresponding to a selection of a report recommendation from amongst the one or more report recommendations rendered say, via the user interface 306. In another instance, the user may provide another input corresponding to a recommendation to merge few report recommendations from amongst the one or more report recommendations rendered say, via the user interface 306. Based on such input(s), the recommendation engine 304 creates the report for the product in consideration based on the context, relevant attributes and report configuration(s), and/or appropriate historical report configuration(s). The report may comprise at least one chapter, one or more parameters (such as, but not limited to quality parameters, process parameters, and/or the like) related to product in consideration, one or more types of graphical representation (such as, but not limited to pie, bar, and/or the like as plots/charts) to represent the one or more parameters, and/or the like in specific format. Such report may also be rendered via the user interface 306 as well. Additionally, the user may also provide feedback on the report configuration list and/or the report rendered say, via the user interface 306 to the report recommendation system 300. It is to be appreciated that the report recommendation system 300 learns from such feedback over the time to improvise its report recommendation(s) and report generation capabilities.

Accordingly, the proposed report recommendation system 300 automates generation of report(s) for appropriate product(s) thereby reducing manual effort and increasing efficiency. The report recommendation system 300 also ensures standardization and consistency across reports, minimizing variability and adhering to industry standards. By leveraging historical data and large language model(s) (LLM), the report recommendation system 300 generates accurate and relevant report configurations. Additionally, the report recommendation system 300 allows users to customize reports based on specific needs at times, enhancing flexibility. The report recommendation system 300 connects to various databases, ensuring comprehensive data utilization and thorough reports. The report recommendation system 300 proposed herein is scalable, suitable for different products and industries, and supports improved decision-making by providing ranked report configurations. Overall, the report recommendation system 300 saves time and enhances productivity by streamlining report generation in the facility.

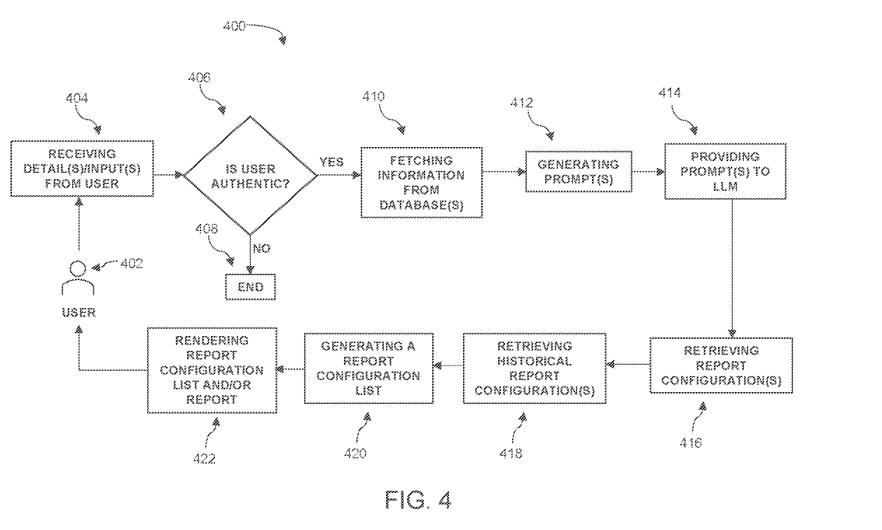

FIG. 4 illustrates a schematic diagram showing an exemplary block diagram associated with one or more operations of exemplary report recommendation system, in accordance with one or more example embodiments described herein. In this regard, the block diagram 400 described herein illustrates a flow of the one or more operations performed by the report recommendation system 300 described in accordance with FIG. 3 of the current disclosure. At block 404, the data processing module 302 described herein initially receives one or more details of a product from a user 402 associated with the facility. Then, at block 406, the data processing module 302 verifies if the user 402 is authentic or legit to access the data associated with the facility. In case that the user 402 is authentic, the flow proceeds to block 410 whereas if the user 402 is not authentic, the flow ends at block 408. At block 410, the data processing module 302 fetches information related to the product from one or more databases associated with the facility. In this regard, the information may comprise raw material information, manufacturing conditions, storing conditions, product genealogy, and/or the like associated with the product. Further, at block 412, the data processing module 302 generates one or more prompts based on the one or more details and the information related to the product in a manner as described in FIG. 3 of the current disclosure. Then, at block 414, the data processing module 302 provides the one or more prompts to appropriate large language model (LLM). At block 416, the data processing module 302 retrieves one or more report configurations using the appropriate large language model (LLM) whereas at block 418, the data processing module 302 retrieves one or more historical report configurations. Then, at block 420, the recommendation engine 304 generates a report configuration list. Upon generating the report configuration list, the recommendation engine 304 makes sure to render the report configuration list and/or report(s) to the user 402 via the user interface 306. Additionally, the report recommendation system 300 may also receive appropriate input(s) along with feedback upon rendering the report configuration list and/or the report(s) to the user 402 at block 404.

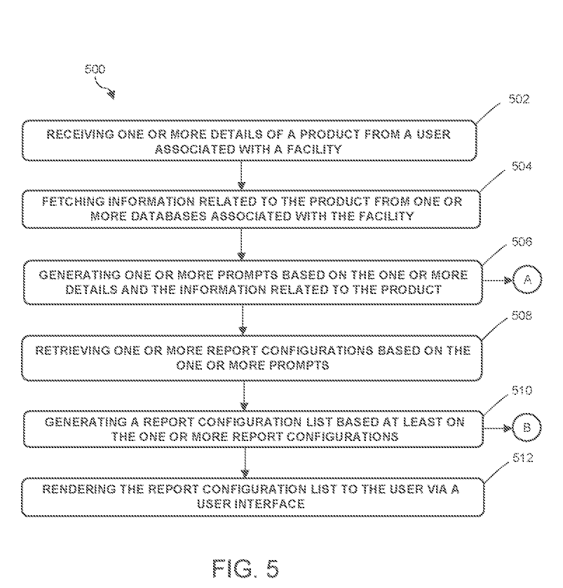

FIG. 5 illustrates a flowchart showing a method described in accordance with one or more example embodiments described herein. In this regard, FIG. 5 illustrates operations that may be performed by the report recommendation system 300. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500. At step 502 of the exemplary flowchart 500, the report recommendation system 300 comprises means such as, the data processing module 302 to receive one or more details of a product from a user associated with a facility. These details may be received via the user interface 306. In this regard, the one or more details comprises at least one of one or more raw material ingredients associated with the product or manufacturing data related to the product. At step 504 of the exemplary flowchart 500, the report recommendation system 300 comprises means such as, the data processing module 302 to fetch information related to the product from one or more databases associated with the facility. In this regard, the information comprises at least one of raw material information, manufacturing conditions, storing conditions, or product genealogy associated with the product. At step bof the exemplary flowchart 500, the report recommendation system 300 comprises means such as, the data processing module 302 to generate one or more prompts based on the one or more details and the information related to the product. At step 508 of the exemplary flowchart 500, the report recommendation system 300 comprises means such as, the data processing module 302 to retrieve one or more report configurations based on the one or more prompts. In this regard, the data processing module 302 provides the one or more prompts to one or more large language models. Further, at step 510 of the exemplary flowchart 500, the report recommendation system 300 comprises means such as, the recommendation engine 304 to generate a report configuration list based at least on the one or more report configurations. While at step 512 of the exemplary flowchart 500, the report recommendation system 300 comprises means such as, the user interface 306 to render the report configuration list to the user. In this regard, the report configuration list comprises the one or more report recommendations.

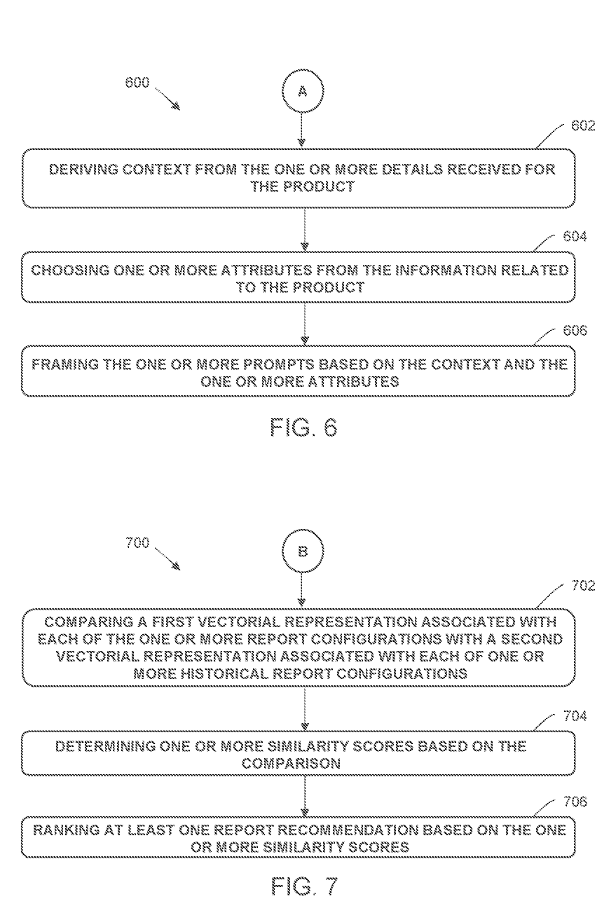

FIG. 6 illustrates a flowchart showing a method described in accordance with one or more example embodiments described herein. In this regard, FIG. 6 illustrates operations that may be performed by the report recommendation system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the report recommendation system 300 comprises means such as, the data processing module 302 to derive context from one or more details received for a product. At step 604 of the exemplary flowchart 600, the report recommendation system 300 comprises means such as, the data processing module 302 to choose one or more attributes from information related to the product. At step 606 of the exemplary flowchart 600, the report recommendation system 300 comprises means such as, the data processing module 302 to frame one or more prompts based on the context and the one or more attributes.

FIG. 7 illustrates a flowchart showing a method described in accordance with one or more example embodiments described herein. In this regard, FIG. 7 illustrates operations that may be performed by the report recommendation system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the report recommendation system 300 comprises means such as, the recommendation engine 304 to compare a first vectorial representation associated with each of one or more report configurations with a second vectorial representation associated with each of one or more historical report configurations. At step 704 of the exemplary flowchart 700, the report recommendation system 300 comprises means such as, the recommendation engine 304 to determine one or more similarity scores based on the comparison. At step 706 of the exemplary flowchart 700, the report recommendation system 300 comprises means such as, the recommendation engine 304 to rank at least one report recommendation based on the one or more similarity scores.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as "thereafter," "then," "next," etc. are not intended to limit the order of the steps; these words are simply used to guide the reader through the description of the methods. Further, any reference to claim elements in the singular, for example, using the articles "a," "an" or "the" is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for providing one or more report recommendations in a facility, the method comprising:
receiving, via a user interface, one or more details of a product from a user associated with the facility;
fetching information related to the product from one or more databases associated with the facility;
generating one or more prompts based on the one or more details and the information related to the product;
retrieving one or more report configurations based on the one or more prompts;
generating a report configuration list based at least on the one or more report configurations; and
rendering, via the user interface, the report configuration list to the user, wherein the report configuration list comprises the one or more report recommendations.

2. The method of claim 1, wherein receiving the one or more details comprises receiving at least one of one or more raw material ingredients associated with the product or manufacturing data related to the product.

3. The method of claim 1, wherein fetching the information related to the product comprises fetching at least one of raw material information, manufacturing conditions, storing conditions, or product genealogy associated with the product.

4. The method of claim 1, wherein generating the one or more prompts comprises:
deriving context from the one or more details received for the product;
choosing one or more attributes from the information related to the product; and
framing the one or more prompts based on the context and the one or more attributes.

5. The method of claim 1, wherein retrieving the one or more report configurations based on the one or more prompts comprises providing the one or more prompts to one or more large language models.

6. The method of claim 1 further comprises retrieving one or more historical report configurations from the one or more databases, wherein the one or more historical report configurations comprise at least one report configuration associated with at least one product similar to the product for which the one or more details are received.

7. The method of claim 6, wherein generating the report configuration list comprises:
comparing a first vectorial representation associated with each of the one or more report configurations with a second vectorial representation associated with each of the one or more historical report configurations;
determining one or more similarity scores based on the comparison; and
ranking at least one report recommendation based on the one or more similarity scores.

8. A system for providing one or more report recommendations in a facility, the system comprising:
a processor;
a memory communicatively coupled to the processor, wherein the memory comprises one or more instructions which when executed by the processor, cause the processor to:
receive, via a user interface, one or more details of a product from a user associated with the facility;
fetch information related to the product from one or more databases associated with the facility;
generate one or more prompts based on the one or more details and the information related to the product;
retrieve one or more report configurations based on the one or more prompts;
generate a report configuration list based at least on the one or more report configurations; and
render, via the user interface, the report configuration list to the user, wherein the report configuration list comprises the one or more report recommendations.

9. The system of claim 8, wherein the one or more details comprises at least one of one or more raw material ingredients associated with the product or manufacturing data related to the product.

10. The system of claim 8, wherein the information comprises at least one of raw material information, manufacturing conditions, storing conditions, or product genealogy associated with the product.

11. The system of claim 8, wherein the processor is further configured to:
derive context from the one or more details received for the product;
choose one or more attributes from the information related to the product; and
frame the one or more prompts based on the context and the one or more attributes.

12. The system of claim 8, wherein the processor is configured to provide the one or more prompts to one or more large language models to retrieve the one or more report configurations.

13. The system of claim 8, wherein the processor is further configured to retrieve one or more historical report configurations from the one or more databases, wherein the one or more historical report configurations comprise at least one report configuration associated with at least one product similar to the product for which the one or more details are received.

14. The system of claim 13, wherein the processor is further configured to:
compare a first vectorial representation associated with each of the one or more report configurations with a second vectorial representation associated with each of the one or more historical report configurations;
determine one or more similarity scores based on the comparison; and
rank at least one report recommendation based on the one or more similarity scores.

15. A non-transitory, computer-readable storage medium having stored thereon executable instructions that, when executed by one or more processors, cause the one or more processors to:
receive, via a user interface, one or more details of a product from a user associated with a facility;
fetch information related to the product from one or more databases associated with the facility;
generate one or more prompts based on the one or more details and the information related to the product;
retrieve one or more report configurations based on the one or more prompts;
generate a report configuration list based at least on the one or more report configurations; and
render, via the user interface, the report configuration list to the user, wherein the report configuration list comprises one or more report recommendations.

16. The non-transitory, computer-readable storage medium of claim 15, wherein the one or more details comprises at least one of one or more raw material ingredients associated with the product or manufacturing data related to the product.

17. The non-transitory, computer-readable storage medium of claim 15, wherein the information comprises at least one of raw material information, manufacturing conditions, storing conditions, or product genealogy associated with the product.

18. The non-transitory, computer-readable storage medium of claim 15, wherein the one or more processors is further configured to:
derive context from the one or more details received for the product;
choose one or more attributes from the information related to the product; and
frame the one or more prompts based on the context and the one or more attributes.

19. The non-transitory, computer-readable storage medium of claim 15, wherein the one or more processors is configured to provide the one or more prompts to one or more large language models to retrieve the one or more report configurations.

20. The non-transitory, computer-readable storage medium of claim 15, wherein the one or more processors is further configured to retrieve one or more historical report configurations from the one or more databases, wherein the one or more historical report configurations comprise at least one report configuration associated with at least one product similar to the product for which the one or more details are received.
